(19) United States
(12) Patent Application Publication
(10) Pub. No.: US 2025/0383629 A1
(43) Pub. Date: Dec. 18, 2025

(54) VARIABLE DEVICE, ROTARY DEVICE, AND TIMEPIECE

(71) Applicant: CASIO COMPUTER CO., LTD., Tokyo (JP)

(72) Inventors: Tatsumi ICHIMURA, Tokyo (JP); Yuma IZUNOME, Tokyo (JP); Masashi TOUKAIRIN, Tokyo (JP); Naoto SEKIYA, Tokyo (JP)

(73) Assignee: CASIO COMPUTER CO., LTD., Tokyo (JP)

(21) Appl. No.: 19/231,697

(22) Filed: Jun. 9, 2025

(30) Foreign Application Priority Data
Jun. 12, 2024 (JP) 2024-094783

(51) Int. Cl. G04B 19/28

(52) U.S. Cl. CPC G04B 19/283

(57) ABSTRACT

Disclosed isa variable device including: a device body that includes an operation member on an outer circumference side; and a cover provided on one surface side of the device body and movable in a direction substantially parallel to the one surface of the device body to take a guard position in which the operation member is allowed to be guarded and a release position in which the operation member is released and allowed to be operated. One of the device body or the cover has a recess of a length corresponding to a movable amount of the cover along a movable direction of the cover, a restrictor placed in the recess is provided on the other of the device body or the cover, and the cover is movable with respect to the device body only within a range corresponding to the length of the recess.

### REFERENCE TO RELATED APPLICATIONS

This application is based upon and claims the benefit of priority from the prior Japanese Patent Application No. 2024-094783, filed on Jun. 12, 2024, the entire contents of which are incorporated herein by reference.

### TECHNICAL FIELD

The present invention relates to a variable device, a rotary device and a timepiece.

### DESCRIPTION OF RELATED ART

JP 2022-87539 A describes a variable device (rotary bezel structure) comprising a device body (timepiece case), and a cover (rotary bezel) provided on one surface side of the device body and movable in a direction substantially parallel to one surface of the device body, in which a recess (groove) is formed in the cover and a restrictor (contact body) is provided that is partially positioned in the recess. is provided in the device body.

### SUMMARY OF THE INVENTION

According to an aspect of the present invention, there is provided a variable device comprising:
a device body that includes an operation member on an outer circumference side; and
a cover that is provided on one surface side of the device body and movable in a direction substantially parallel to the one surface of the device body to take a guard position in which the operation member is allowed to be guarded and a release position in which the operation member is released and allowed to be operated, wherein
one of the device body or the cover has a recess of a length corresponding to a movable amount of the cover along a movable direction of the cover,
a restrictor placed in the recess is provided on the other of the device body or the cover, and
the cover is movable with respect to the device body only within a range corresponding to the length of the recess.

### BRIEF DESCRIPTION OF DRAWINGS

FIG. 1 is a front view of a timepiece including a rotary device according to an embodiment;

FIG. 2 is a diagrammatic view of a rotator of the rotary device shown in FIG. 1, viewed from the side where it is attached to the device body;

FIG. 3 is a schematic illustration showing an image of a restrictor moving in a recess of the rotator relative to the recess;

FIG. 4 is a cross-sectional view along the A-A line shown in FIG. 1;

FIG. 5 is a front view of the timepiece showing the rotator of the rotary device rotated clockwise about 22.5 degrees from the state shown in FIG. 1;

FIG. 6 is a cross-sectional view along the B-B line shown in FIG. 5;

FIG. 7 is a front view of the timepiece showing the rotator of the rotary device rotated 45 degrees clockwise from the state shown in FIG. 1;

FIG. 8 is a cross-sectional view along the C-C line shown in FIG. 7;

FIG. 9 is a front view of a timepiece including a rotary device according to a modification example;

FIG. 10 is a cross-sectional view along the D-D line shown in FIG. 9;

FIG. 11 is a front view of a timepiece including a variable device according to the embodiment, showing a variable member in a release position; and

FIG. 12 is a front view of the timepiece including the variable device shown in FIG. 11, showing the variable member in a guard position.

### DETAILED DESCRIPTION

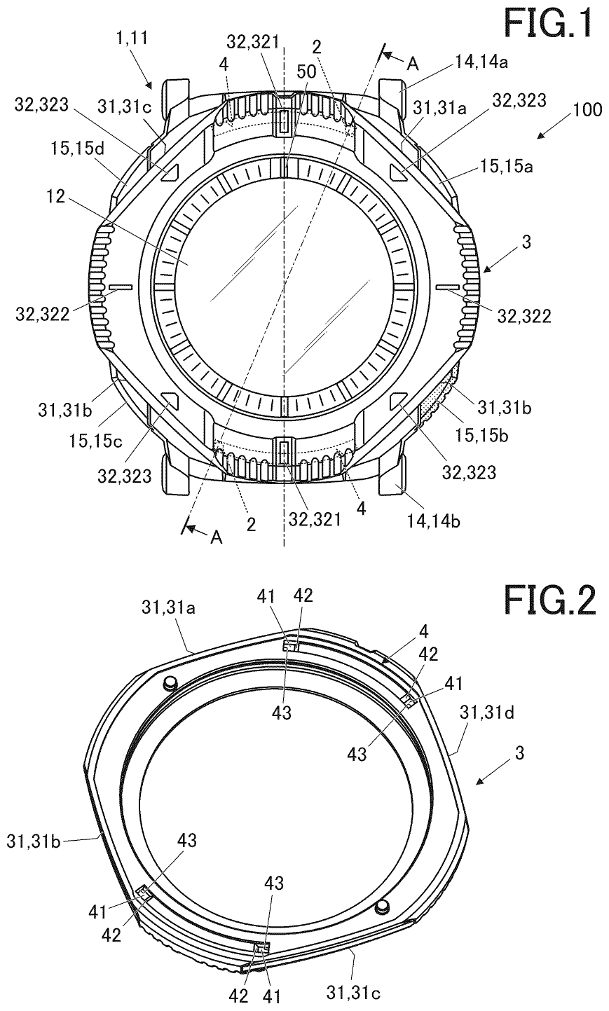

With reference to FIGS. 1 to 8, an embodiment of a timepiece including a rotary device (variable device) in accordance with the present invention will be described. In this embodiment, a case in which a rotary device is applied to a wristwatch (hereinafter simply referred to as a timepiece) that is worn on the arm is exemplified. The embodiments described below are subject to various technically preferred limitations in order to implement the present invention, but the scope of the present invention is not limited to the following embodiments and illustrated examples.

As shown in FIG. 1, the rotary device (variable device) in this embodiment includes a device body 1 and a rotator 3, which is a cover. The timepiece 100 includes at least a rotary device (variable device). In the following embodiment, the timepiece 100 including the rotary device has an approximately circular device body 1. In the following, the state in which the rotator 3 is positioned so that a first indicator 321 of the rotator 3 described below is positioned at the 12 o'clock and 6 o'clock positions in the timepiece (the state shown in FIG. 1) is the state in which the rotator 3 is in the reference position. As described below, the rotator 3 can rotate circumferentially from this reference position as the starting point (0-degree position) when rotating to a position that is 45 degrees clockwise (end position of rotation). In FIGS. 1, 5, and 7, the line connecting the 12 o'clock and 6 o'clock positions in the timepiece is shown as a single dotted line. Furthermore, in FIGS. 1, 5, and 7, the components on the back surface side of the rotator 3 that are not actually visible on the surface (that is, restrictors 2 and recesses 4 described below) are shown as dashed lines.

JP 2022-87539 describes a variable device (rotary bezel structure) comprising a device body (timepiece case), a cover (rotary bezel) provided on one surface side of the device body and movable in a direction substantially parallel to one surface of the device body, in which a recess (groove) is formed in the cover and a restrictor (contact body) that is partially positioned in the recess is provided in the device body.

However, there was no assumption that the cover could guard the operation member or release the operation member to allow operation. The present invention is intended to improve and solve problems of this situation, and to enable the cover to take the position of guarding the operation member and the position of being able to operate the operation member.

In the embodiment, the device body 1 constitutes the main body of the timepiece 100. The device body 1 has a body case 11 formed, for example, of various synthetic resins. The material forming the body case 11 is not limited to resin, but may be, for example, a metal such as stainless steel or titanium, or a ceramic. The body case 11 of the embodiment is formed in the shape of a hollow short column that is open at the top and bottom in the height direction H (thickness direction, see FIG. 4, and the like) of the timepiece. A windshield member 12 made of transparent glass, for example, is attached to the opening on the front surface side (visible side) of the body case 11 to block the opening on the front surface side. The opening on the back surface side of the body case 11 is closed by a back cover member 13 (see FIG. 4, and the like). The timepiece 100 incorporates modules and other components, including a display section not shown in the figure, inside the body case 11 and below the windshield member 12. The display section may be an analog display section including a pointer or the like, which is not shown, or it may be a digital display section including a liquid crystal display, for example. It may also be a hybrid type display that has both digital and analog display sections.

The body case 11 also has a pair of band attachment portions 14 at opposing positions. The “opposing positions” are, for example, the 12 o'clock side end and the 6 o'clock side end of an analog timepiece. In FIG. 1, the band attachment portion 14 at the 12 o'clock side end is designated as a band attachment portion 14a, and the band attachment portion 14 at the 6 o'clock side end is designated as a band attachment portion 14b. In the embodiment, the band attachment portion 14a and the band attachment portion 14b have the same shape and configuration. When simply referring to “band attachment portions 14”, the band attachment portions 14a and 14b are included. By attaching a band, not shown in the figure, to the band attachment portions 14, the timepiece 100 including the device body 1 can be attached to an arm (wrist, and the like).

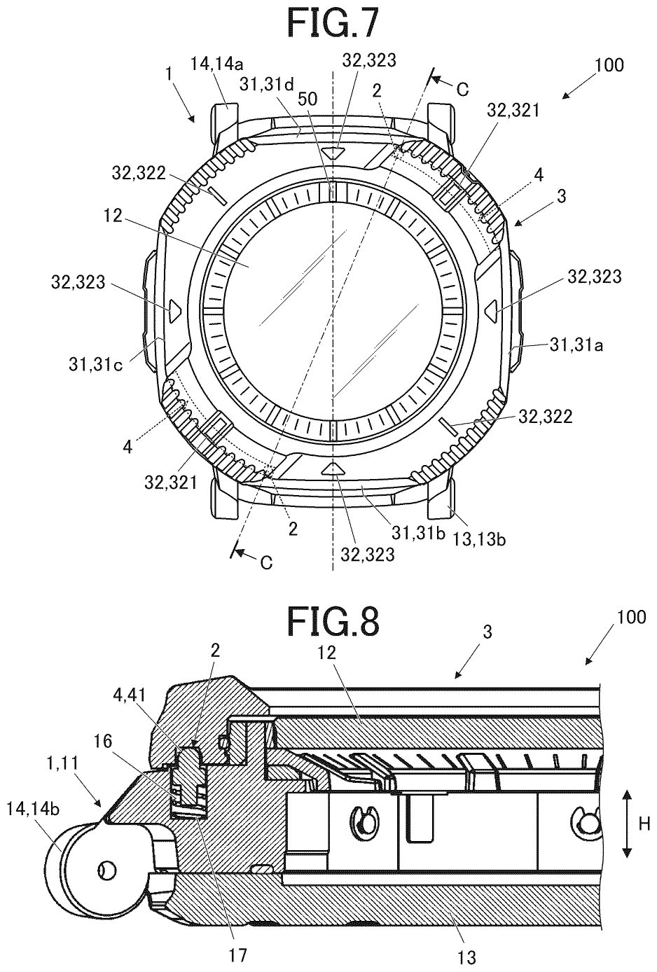

A plurality of operation members 15 configured to enable input of various operation instructions, such as instructions for setting the time and switching the display on the display section, are provided on the side portion of the body case 11 (outer circumference of the body case 11). In the embodiment, the operation members 15 are, for example, operation buttons that are operated by the user pushing them in to perform various input operations. The operation member 15 is not limited to an operation button, but can be, for example, a crown or the like. In the embodiment, as shown in FIG. 1, four operation members 15 are arranged at approximately equal intervals (in the illustrated example, arranged between the 1 o'clock and 2 o'clock positions, between the 4 o'clock and 5 o'clock positions, between the 7 o'clock and 8 o'clock positions, and between the 10 o'clock and 11 o'clock positions in the analog timepiece, respectively). It is sufficient that at least one operation member 15 is located on the side portion of the body case 11, and the number and arrangement of operation members 15 are not limited to the illustrated example. The operation member 15 becomes operable by releasing the upper surface side (visible side in the timepiece) when the rotator 3 (described below) is in the reference position shown in FIG. 1. When the rotator 3 is rotated about 45 degrees clockwise from the reference position (as shown in FIG. 7), the upper surface side of the operation member 15 is covered and guarded by the rotator 3.

In the following, the operation member provided between the 1 o'clock and 2 o'clock positions on an analog timepiece is referred to as an operation member 15a, the operation member provided between the 4 o'clock and 5 o'clock positions as an operation member 15b, the operation member provided between the 7 o'clock and 8 o'clock positions as an operation member 15c, the operation member provided between the 10 o'clock and 11 o'clock positions as an operation member 15d. When simply referring to “operation members 15,” these four operation members 15a through 15d are included. Although all operation members 15 may be similar in color and shape, it is preferable that the operation members 15 that are used frequently or assigned important functions be marked with a conspicuous color having good visibility, such as orange, to easily distinguish them from other operation members 15. Frequently used operation members 15 are, for example, operation members 15 to which frequently used functions are assigned, such as buttons for starting and stopping a stopwatch. In the embodiment, only the operation member 15b provided between the 4 o'clock and 5 o'clock positions is colored orange or the like. The conspicuous color is not limited to orange, but may be any fluorescent color, for example. The operation member 15 can be operated intuitively by indicating functions with different colors, and the like, without using more text than necessary to indicate functions on the operation member 15. Furthermore, by adding a color to the top surface (front surface) portion of the operation member 15, which is the visible side, it is easy to see whether the operation member 15 is released and operable or hidden and guarded by the rotator 3, allowing the user to visually and intuitively grasp the change of state. In this embodiment, the operation member 15, the hour character 50 at 12 o'clock position, and the indicator 32, are in a highly visible color, for example orange. When the button guard is released (reference position) shown in FIG. 1, it is easy to see that the orange indicator 32 of the rotator 3 is at the orange hour character of the timepiece (hour character 50 at 12 o'clock position), so that the orange operation member 15 can be used. The alignment of the indicator 32 with the hour character 50 at the 12 o'clock position serves as a marker that the rotator 3 cannot be rotated any further. When the button is guarded (the upper surface side of the operation member 15 is covered and guarded by the rotator 3) shown in FIG. 7, the orange indicator 32 of the rotator 3 is also shifted 45 degrees clockwise from the orange hour character of the timepiece (hour character 50 at the 12 o'clock position). Therefore, the orange operation member 15 is hidden under the rotator 3 when the user looks at it from the top, making it easy to recognize that it is not usable.

On the upper end surface of the device body 1, recesses 16 with depth in the height direction H (see FIG. 4, and the like) are formed in two approximately point-symmetrical locations, and a restrictor 2 is placed in each of the recesses 16. In the embodiment, as shown in FIG. 1, the recesses 16 are provided on the 12 o'clock side and the 6 o'clock side in the timepiece. The recesses 16 on the 12 o'clock side and on the 6 o'clock side have almost the same configuration and shape. The restrictors 2 disposed in the respective recesses 16 also have approximately the same configuration and shape.

The restrictor 2 is a long shaft member in the height direction H (thickness direction, see FIG. 4, and the like) in the timepiece 100. The restrictor 2 is formed, for example, of a hard synthetic resin. The material for forming the restrictor 2 is not limited to this and may be made of various metals, for example. Almost at the center of the height direction H of the restrictor 2 is a flange portion 21 extending outward from the outer circumference of the restrictor 2. A force member 17, such as a coil spring, for example, is disposed in the recess 16. When the restrictor 2 is placed in the recess 16, the portion of the restrictor 2 below the flange portion 21 is fitted into the inside of the force member 17 (for example, inside the coil spring), and the upper end of the force member 17 contacts the lower surface of the flange portion 21.

In the assembled state, the restrictor 2 is being forced upward in the height direction H by the force member 17. As mentioned above, in the assembled state, the rotator 3 is placed on the upper surface of the body case 11 of the device body 1. A recess 4 having a length corresponding to the rotation amount of the rotator 3 is formed along the rotation direction of the rotator 3 (that is, the circumferential direction in the substantially annular rotator 3) at the position corresponding to the 12 o'clock side and 6 o'clock side in the timepiece on the surface of the rotator 3 facing the device body 1. In the assembled state, the restrictor 2 is positioned at a position corresponding to one end of the recess 4 (right end of the recess 4 at 12 o'clock side and left end of the recess 4 at 6 o'clock side in the illustrated example), respectively. The upper tip 22 of the restrictor 2, which is forced upwardly in the height direction H by the force member 17, protrudes from within the recess 16 and fits into the interior of the recess 4 described below of the rotator 3, which is disposed on the upper surface of the device body 1.

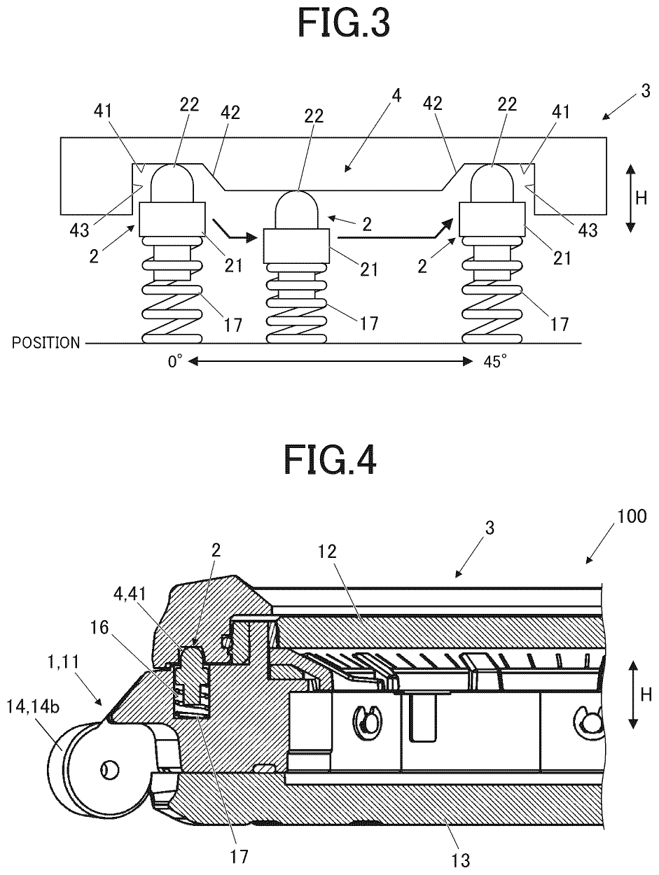

The restrictor 2 protrudes toward the bottom surface of the recess 4 and is pressed against the bottom surface of the recess 4 by the force in the height direction H (protruding direction) by the force member 17. When the rotator 3 rotates, the restrictor 2 slides tracing the bottom surface of the recess 4 and changes its position relative to the recess 4, while being pressed against the bottom surface of the recess 4 by the force member 17. The tip 22 (protruding end) of restrictor 2 has a rounded shape, as shown, for example, in FIGS. 3, 4, and the like. Therefore, even when the tip 22 of the restrictor 2 is protruding into the recess 4, load resistance during movement can be minimized, and the rotator 3 can rotate with less resistance. Furthermore, the entire restrictor 2 is a cylindrical shaft and rotationally symmetrical about a central axis. By making the restrictor 2 in such a shape, it is directional only vertically and does not require positioning in the rotation direction. This reduces the workload when assembling the restrictor 2 to the device body 1.

The rotator 3 is an substantially annular member provided rotatably on the upper surface of the device body 1. The rotator 3 is a cover that varies its position by rotating around its annular center and can take a guard position, in which the operation member 15 can be guarded, and a release position, in which the operation member 15 can be released and operated. As shown in FIG. 1, the rotator 3 has notches 31a, 31b, 31c, and 31d, respectively, by having part of the outer circumference between the 3 o'clock and 6 o'clock positions, between the 6 o'clock and 9 o'clock positions, between the 9 o'clock and 12 o'clock positions, and between the 12 o'clock and 3 o'clock positions in the analog timepiece cut out. As a result, the outer circumferential edge of the rotator 3 corresponding to the four notches 31a, 31b, 31c, and 31d is placed on the inner side than the outer circumferential edge of the 3, 6, 9, and 12 o'clock positions. Generally, rotary bezels and other rotators are circular in shape, but by notching a portion of the rotator 3, the outer shape becomes square or octagonal. By making the external shape of the rotator 3 other than circular, the finger is better able to catch the rotator 3 when rotating it, thereby improving operability. In addition, by slimming down the shape of the rotator 3, especially on the 3 o'clock and 9 o'clock sides, it is possible to reduce the catching of the sleeve portion when putting on and taking off a jacket, and the like.

The notches 31a, 31b, 31c, 31d are positioned corresponding to the operation members 15a, 15b, 15c, 15d of the device body 1, respectively, when the rotator 3 is in the reference position shown in FIG. 1. Therefore, when the rotator 3 is in the reference position, the upper side of each operation member 15a, 15b, 15c, 15d is released and operable. This state shown in FIG. 1 is the state in which the rotator 3 is in the release position. In this state, the operation member 15 is largely exposed, which improves the visibility of the operation member 15.

In contrast, when the rotator 3 is rotated clockwise by approximately 45 degrees from the reference position (starting position of rotation), as shown in FIG. 7, portions other than the notches 31a, 31b, 31c, 31d are placed at positions corresponding to the respective operation members 15a, 15b, 15c, 15d. In this state, the upper side of each operation member 15a, 15b, 15c, 15d is covered and guarded by the rotator 3. This state shown in FIG. 7 is the state in which the rotator 3 is in the guard position. In this state, the operation member 15 is hidden under the rotator 3, making the time display, and the like on the timepiece 100 relatively prominent. This is also expected to improve the legibility of the time, and the like. Furthermore, as in the embodiment, the operation member 15 can be guarded by the rotator 3, thereby eliminating the risk of the operation member 15 being caught on a sleeve or the like, even if the operation member 15 is formed relatively large. Therefore, when the rotator 3 is in the release position, the operation member 15 is easier to push and easier to operate even when wearing gloves, for example.

The surface of the rotator 3 is provided with indicators 32 indicating various positions, and the like along the circumferential direction. The indicators 32 may be provided by printing or by laser processing, and the like. In the embodiment, the indicators 32 are arranged as follows. That is, the first indicator 321 is provided at locations corresponding to the 12 o'clock position and the 6 o'clock position in the rotator 3, respectively. Second indicators 322 are provided at the locations corresponding to the 3 o'clock position and the 9 o'clock position, respectively, on the rotator 3. Furthermore, third indicators 323 are provided between the first indicators 321 and the second indicators 322, respectively.

Of these, the first indicators 321 should be larger and more prominent than the other indicators, as shown in FIG. 1, to indicate the 12 o'clock and 6 o'clock positions, which are the reference points for checking the time. As described below, the rotator 3 can rotate within a range of 45 degrees from the state shown in FIG. 1 (in the starting position of rotation). When the first indicator 321 is positioned at the 12 o'clock and 6 o'clock positions, it can rotate clockwise but cannot rotate any further counterclockwise. The first indicator 321 also functions as an indicator of the direction in which the rotator 3 can rotate and the range in which the rotator 3 can move.

When the first indicator 321 is positioned at the 12 o'clock and 6 o'clock positions as shown in FIG. 1, the rotator 3 is in the release position which allows the operation member 15 to be operated. The first indicator 321 thus also functions as an indicator to show whether the rotator 3 is in the release or guard position. In other words, when the first indicator 321 is positioned at the 12 o'clock and 6 o'clock positions as shown in FIG. 1, the user can recognize that the rotator 3 is in the release position in which the operation member 15 can be operated. When the rotator 3 is in the reference position as shown in FIG. 1, the third indicator 323 is positioned at positions corresponding to the operation members 15a, 15b, 15c, and 15d on the device body 1, respectively. This allows the user to easily grasp the positions of the operation member 15 by looking at the rotator 3. In addition, the third indicator 323 in the embodiment is a triangular icon, which also serves as an auxiliary indication of the direction in which the operation member 15 is pushed in. With the rotator 3 in the guard position, the third indicator 323 is positioned at the 3 o'clock, 6 o'clock, 9 o'clock, and 12 o'clock positions, respectively. Thus, they also serve as aids to deciphering the time.

On the back surface side of the rotator 3 of the embodiment (the side facing the device body 1), recesses 4 with a length corresponding to the rotation amount of the rotator 3 are formed along the rotation direction of the rotator 3. As mentioned above, the restrictor 2 protrudes from the device body 1 side into the recess 4 in the assembled state. The outer circumference of the recess 4 is a vertical wall almost perpendicular to the upper surface of the device body 1, and the restrictor 2 cannot climb over this vertical wall. The rotator 3 is rotatable with respect to the device body 1, but its rotatable range is restricted to the extent that the restrictor 2 does not butt up against the vertical wall of the recess 4.

The ends 41 on both sides of the length direction in the recess 4 are deeper, relative to the center of the length direction, in the height direction H of the timepiece 100 (thickness direction, the direction of the protrusion of the restrictor 2, see FIGS. 3 and 4, and the like). As mentioned above, when the rotator 3 rotates, the restrictor 2 on the device body 1 side changes position relative to the recess 4. The restrictor 2 is, as mentioned above, forced toward the upper side of the device body 1, that is, the side of the rotator 3, by the force member 17, and remains pressed against the bottom surface of the recess 4 even when the rotator 3 is rotating. Therefore, when the depth of the recess 4 located at the position corresponding to the restrictor 2 changes, the amount of protrusion of the restrictor 2 into the recess 4 changes accordingly.

The relationship between the recess 4 and the restrictor 2 will now be described in detail with reference to FIGS. 1 to 3. As shown in FIGS. 1 and 2, in the embodiment, the recess 4 is formed on the back surface side of the rotator 3 in a range from 0 to 45 degrees in the circumferential direction with respect to a position corresponding to the portion where the first indicator 321 is provided on the front surface side. More specifically, in the illustrated example, the recess 4 is an approximately arc-shaped groove having a spread of about 22.5 degrees in the clockwise direction and about 22.5 degrees in the counterclockwise direction (overall, about 0 to 45 degrees as shown in FIG. 3) with respect to the position corresponding to the first indicator 321. In FIG. 3, the varying position of the recess 4 that is actually arc-shaped is shown schematically in linear form for illustration.

The 0 degree position in FIG. 3 is the starting point position of the rotation of the rotator 3. FIGS. 1 and 4 correspond to the state where the rotator 3 is at the 0 degree position. The 45-degree position in FIG. 3 is the end position of the clockwise rotation of the rotator 3, and FIGS. 7 and 8 correspond to the state where the rotator 3 is at the 45-degree position. As shown in FIG. 3, FIG. 1, FIG. 4, and FIGS. 7 and 8, in a state where the rotator 3 is in the reference position before the rotation of the rotator 3 (at the 0-degree position in FIG. 3) and in a state where the rotator 3 has rotated by the full length of the recess 4 (at the 45-degree position in FIG. 3), the end 41, the deeper portion of the recess 4, is positioned on the upper side of the restrictor 2. Therefore, the restrictor 2, which is being forced in the upward direction by the force member 17, protrudes to the upper end (bottom surface) of the end 41.

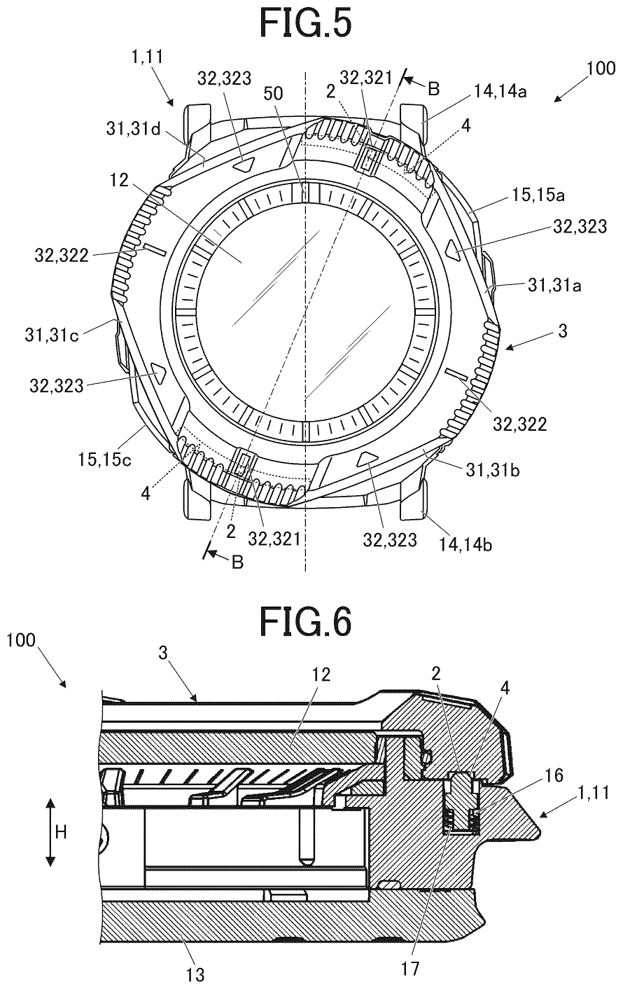

In contrast, at the middle of both locations, the depth in the height direction H of the recess 4 is shallower than at both ends (ends 41). Therefore, as shown in FIGS. 5 and 6, the amount of protrusion of the restrictor 2 into the recess 4 is also smaller than the protrusion at the ends 41. As mentioned above, when the rotator 3 rotates and varies its position, the restrictor 2 is still pressed against the upper end (bottom surface) of the recess 4 by the force member 17 and its tip is maintained to trace the bottom surface of the recess 4. Therefore, when the restrictor 2 moves from the shallow depth to the deep depth end 41, the restrictor 2 is pushed to the end 41 by the force member 17, generating a clicking sensation. The bottom surface of the recess 4 has an sloping surface 42 (see FIGS. 2 and 3) that slopes toward the central portion in the length direction, and between the other end (end 41) and the central side in the length direction. This allows the restrictor 2 to overcome the step along the sloping surface 42 even when the restrictor 2 moves relatively from both ends (end 41), where the depth in the height direction H of the recess 4 is deep, to the shallow depth portion in the middle of both points as the rotator 3 rotates. As a result, there is less snagging and resistance when the rotator 3 moves, allowing it to move smoothly. At one end and the other end in the length direction of the recess, a stop surface 43 is formed at an angle steeper than the sloping surface 42 with respect to the bottom surface of the recess. The stop surface 43 has an angle that is, for example, perpendicular to the bottom surface of the recess 4. This ensures that the restrictor 2 does not exceed the stop surface 43 of the recess 4.

Next, the action of the rotary device and the timepiece 100 including the rotary device will be described. In assembling the rotary device and the timepiece 100 including the rotary device, the operation member 15 is first attached to the outer side portion of the device body 1, the modules and other components are housed in the body case 11, and the windshield member 12 and the back cover member 13 are attached. Then, the force member 17 is placed in the recess 16 formed in the device body 1, and the restrictor 2 is placed in the recess 16 with the flange portion 21 riding on top of the force member 17. Then, the rotator 3, with recess 4 formed at the 12 o'clock and 6 o'clock positions in the reference position in the assembled state, is placed on the device body 1 with the surface having the recess 4 facing the upper surface of the device body 1. At this time, the rotator 3 is installed so that it is in the reference position where the first indicator corresponds to the 12 o'clock and 6 o'clock positions on the timepiece. This completes the assembly of the timepiece 100 including the rotary device and the rotary device, with the restrictors 2 placed in the ends 41 of the recesses 4, respectively.

As shown in FIG. 1, in the state in which the rotator 3 is positioned in the orientation in which the first indicator 321 is placed at the 12 o'clock and 6 o'clock positions in the timepiece (the rotator 3 is in the reference position), the restrictor 2 protruding from the device body 1 side is formed at one end of the recess 4 formed on the back surface side of the rotator 3 as shown in FIG. 1 in broken line (in the example shown in FIG. 1, the end 41 near the 1 o'clock side and end 41 near the 7 o'clock side of the recesses 4). In this state, when the rotator 3 is attempted to rotate counterclockwise, the restrictor 2 butts against the stop surface (vertical wall) 43 of the recess 4. Thus, the counterclockwise movement of the rotator 3 is restricted.

With the rotator 3 in the reference position, the notches 31 of the rotator 3 are placed at the positions corresponding to the operation members 15 on the device body 1, respectively, as shown in FIG. 1. As a result, the upper sides of the operation members 15 are released and can be operated by the user. When the rotator 3 is in the reference position, the third indicator 323 is placed in a position corresponding approximately to each of the operation members 15. Therefore, the user can recognize the position of the operation member 15 simply by checking the position of the third indicator 323.

The end 41 of the recess 4 of the rotator 3 has deeper depth in the height direction H in the recess 4. Therefore, with the end 41 in the position corresponding to the restrictor 2, the amount of protrusion of the restrictor 2 toward the rotator 3 in the state of being forced by the force member 17 is larger, as shown in FIGS. 3 and 4. When the rotator 3 is rotated clockwise from this state, a shallow depth portion of the recess 4 is placed at the position corresponding to the restrictor 2. In this state, as shown in FIGS. 3 and 6, the restrictor 2 and the force member 17 are pressed down by the bottom surface (upper surface) of the recess 4. The middle portion between the deep end 41 and the shallow center portion in the recess 4 is provided with the sloping surface 42 that slopes toward the center portion. Therefore, the rotator 3 can smoothly go over the tip 22 of the restrictor 2 even when the middle portion from the end 41 to the center portion passes through the portion where the restrictor 2 is arranged.

When the rotator 3 is further rotated clockwise and varies its position to a position that is almost 45 degrees from the reference position, the restrictor 2 fits into the opposite end 41 of the recess 4, as shown in FIGS. 7 and 8. At the moment the portion of the recess 4 corresponding to the restrictor 2 goes from shallow to deep (end 41) in the height direction H, the restrictor 2 is pushed into the end 41 by the force member 17, which generates a clicking sensation.

When the rotator 3 rotates 45 degrees from the starting position of rotation (0 degrees in FIG. 3) to the position where the restrictor 3 fits into the end 41, the restrictor 2 butts against the stop surface (vertical wall) 43 of the end 41, which makes it impossible to rotate the rotator 3 clockwise any further. When the rotator 3 is in the position where it has rotated 45 degrees from the starting position of rotation, as shown in FIG. 7, the upper sides of the operation members 15 on the device body 1 are all covered by the rotator 3 and are in a guarded state where they cannot be freely operated. To make the operation member 15 operable again from this state, rotate the rotator 3 counterclockwise by about 45 degrees and return it to the state shown in FIG. 1 (reference position of the rotator 3). When returning the rotator 3 to the reference position, the portion of the recess 4 corresponding to the restrictor 2 also varies its position from the shallow portion to the deep portion (end 41) in the height direction H. As a result, at the moment the end 41 is placed in the position corresponding to the restrictor 2, the restrictor 3 is pushed into the end 41 by the force member 17 and a clicking sensation is generated.

Thus, in this embodiment, the rotator 3 can rotate up to about 45 degrees clockwise from the starting position of rotation, and at the starting and ending positions of rotation, the restrictor 2 butts against the stop surface (vertical wall) 43 of the recess 4, and the movement of the rotator 3 is restricted to the range where the recess 4 is provided. Therefore, the rotator 3 can move only within the predetermined range. At the starting position of rotation, the operation member 15 can be operated, and at the end point of rotation, operation of the operation member 15 is guarded, allowing the user to switch the position of the rotator 3 as needed.

As described above, in this embodiment, a device such as a timepiece 100 includes a rotary device that includes a device body 1 including an operation member 15 on its side portion, and a rotator 3, which is an substantially annular member provided on the upper surface of the device body 1 so as to be rotatable around the annular center to vary its position to take a guard position in which the operation member 15 can be guarded, and a release position in which the operation member 15 can be released and made operable. The rotator 3 of the rotary device of the embodiment has a recess 4 along the rotation direction of the rotator 3 with a length corresponding to the amount of rotation of the rotator 3, and the device body 1 is provided with a restrictor 2 that is disposed within the recess 4, and the rotator 3 is rotatable relative to the device body 1 in the range corresponding to the length of the recess 4. This allows the rotator 3 to be rotated relative to the device body 1 within a predetermined range (for example, up to 45 degrees clockwise when the reference starting position of rotation is 0 degrees), and the position of the rotator 3 can be easily switched between a position in which the operation member 15 can be operated and a position in which the operation member 15 is guarded. This makes it possible to easily and reliably prevent unintentional changes in settings, and the like due to inadvertent operation of the operation member 15.

The restrictor 2 in the embodiment protrudes toward the bottom surface of the recess 4 (upper surface in FIGS. 3 and 4, and the like) and is forced in the protruding direction so as to trace the bottom surface of the recess 4. Thus, in the embodiment, the restrictor 2 is guided along the recess 4 when the device body 1 and the rotator 3 move relative to each other. This allows the rotatable range of the rotator 3 to be easily restricted to a range where the restrictor 2 does not butt against or come off the recess 4, allowing the rotator 3 to operate precisely within the limited range between the release and guard positions of the operation member 15.

The ends in the length direction (ends 41) in the recess 4 in the embodiment are deeper relative to the center in the length direction in the direction of the protrusion of the restrictor 2 (height direction H of the timepiece 100). This allows the restrictor 2 to generate a clicking sensation when it is fitted into the end 41.

The bottom surface of the recess 4 in the embodiment has a sloping surface 42 that slopes toward the central portion in the length direction between one end 41 in the length direction and the central portion in the length direction, and between the other end 41 in the length direction and the central portion in the length direction. This allows the rotator 3 to move smoothly even after the restrictor 2 is once fitted into the end 41 of the recess 4. In other words, as shown in FIG. 3, and the like, even if the position in the recess 4 corresponding to the restrictor 2 shifts from the end 41 to the center of the recess 4, which is shallower in depth than the end 41, as the rotator 3 rotates, the restrictor 2 does not get caught and the rotator 3 can move smoothly. Furthermore, at one end and the other end in the length direction of the recess 4 of the rotator 3, which is a cover, a stop surface (vertical wall) 43 is formed at an angle steeper than the sloping surface 42 with respect to the bottom surface of the recess 4. The restrictor 2 cannot go over the stop surface (vertical wall) 43, and when the restrictor 2 butts against the stop surface (vertical wall) 43, the rotator 3 cannot move any further. Therefore, the movement of the rotator 3 is restricted to the range where the recess 4 is provided.

On the surface of the rotator 3 in the embodiment, there is an indicator 321 that indicates that the rotator 3 is in the release position when the rotator 3 varies its position to the release position. This makes it easy to check whether or not the operation member 15 is operable in the rotary device by simply looking at the rotator 3.

The surface of the rotator 3 in the embodiment is provided with an indicator 321 that indicates the movable range of the rotator 3. This allows the user to easily confirm whether or not the rotator 3 can be further rotated simply by looking at the indicator 321 of the rotator 3. This prevents the user from damaging the device by forcibly trying to rotate the rotator 3 beyond the movable range.

Furthermore, the surface of the rotator 3 in the embodiment is provided with an indicator 323 indicating the position of the operation member 15. This allows the user to easily confirm the position of the operation member 15 simply by looking at the indicator 323 on the rotator 3.

The timepiece 100 in the embodiment includes a rotary device with a device body 1 and a rotator 3. Therefore, by simply rotating the rotator 3, the device can easily switch between a state in which the operation member 15 can be operated and a state in which the operation member 15 is guarded against inadvertent operation.

Although the embodiments of the present invention have been described above, it goes without saying that the present invention is not limited to such embodiments and can be varied in various ways without departing from the gist thereof.

For example, in the above embodiment, the case in which four operation members 15 that can be switched between release and guard states by the rotator 3 is illustrated, but at least one operation member 15 is required. It is sufficient that the rotator 3 can take a guard position in which the operation member 15 can be guarded and a release position in which the operation member 15 is released to be operable. The shape of the rotator 3 and the position and range of the recess 4 can be changed as needed according to the number and arrangement of the operation members 15.

In the above embodiment, an example is shown in which only both ends of the recess 4 have a deeper depth in the height direction H. However, the shape of the recess 4 is not limited to this. For example, it is possible to provide alternating deep and shallow portions in the recess 4 in the height direction H, so that a clicking sensation can be generated in small increments by moving the rotator 3 gradually.

In the above embodiment, the case in which the rotator 3 covers only the upper surface of the operation member 15 in the guard position is illustrated, but the state in which the operation member 15 is guarded is not limited to the state in which the upper surface is covered. For example, the rotator 3 may be provided with side walls hanging down to the device body 1 side at all or part of its outer circumference. In this case, when the rotator 3 is placed in the guard position, the operation member 15 is guarded not only from the top but also from the side, which more reliably prevents unintended operations.

In the above embodiment, the case in which a recess 4 is formed in the rotator 3 and a restrictor 2 is provided in the device body 1, which is disposed in the recess 4, is illustrated, but it is sufficient if the recess is provided in one of the device body 1 and the rotator 3 and the restrictor is provided in the other of the device body 1 and the rotator 3.

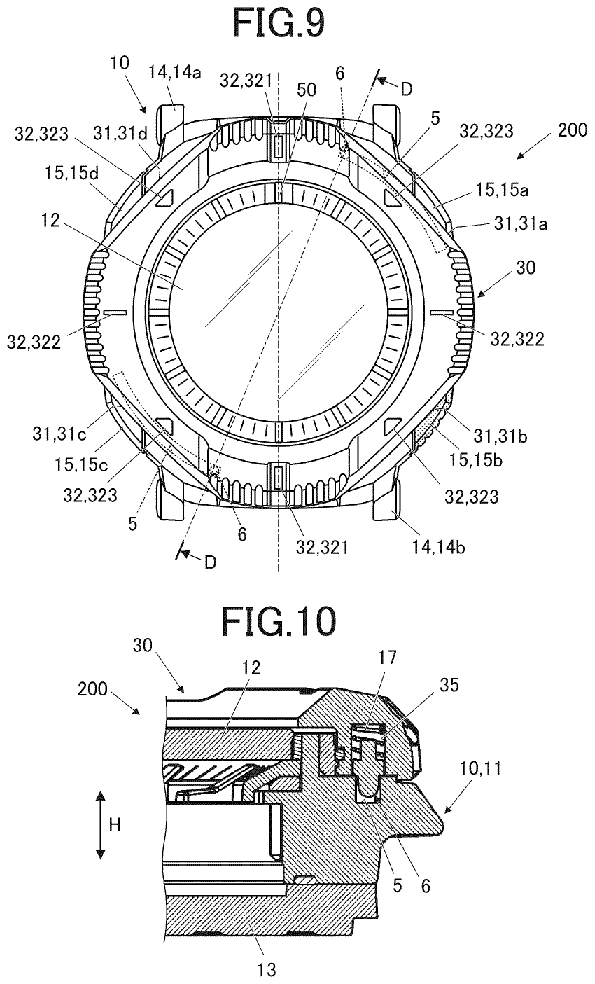

For example, as shown in FIGS. 9 and 10, the timepiece 200 may include a rotary device having a device body 10 with a recess 5 and a rotator 30 with a restrictor 6. The rotator 30 has a recess 35 at the position where the restrictor 6 is provided, and the restrictor 6 is positioned in the recess 35 via a force member 17. As a result, the restrictor 6 is forced toward the lower side of the height direction H from the rotator 30 side to the device body 10 side by the force member 17. In this case, the other structures are the same, except that the positional relationship between the member in which the recess 5 is provided and the member in which the restrictor 6 is provided differs from the embodiment shown in FIGS. 1 to 8. For this reason, similar members are marked with the same symbols and their explanations are omitted.

In this case, as shown in FIG. 9, the recess 5 is formed on each of the upper surface of the device body 10 near where the operation member 15a corresponding to the notch 31a of the rotator 3 is provided in the reference position and the upper surface of the device body 10 near where the operation member 15c corresponding to the notch 31c of the rotator 3 is provided. The restrictor 6 is provided at positions corresponding to the ends of the recesses 5 of the device body 10 side on the back surface side of the rotator 30 (corresponding to the upper surface of the device body 10). Specifically, as shown in FIG. 9, the restrictor 6 corresponding to the recess 5 on the operation member 15a side and the restrictor 6 corresponding to the recess 5 on the operation member 15c side are located at the left and right ends of the recess 5, respectively. In this case, too, the ends of the recess 5 in the length direction may be deeper in the height direction H (see FIG. 10) than the center. Although not shown in the figure, when the depth of both ends of the recess 5 in the length direction is made deeper in this way, it is preferable, as in the embodiment, to provide a sloping surface between the ends of the recess 5 in the length direction and the center of the recess 5 where the depth in the height direction H is shallower than this.

Thus, even when the recess 5 is provided on the device body 10 side and the restrictor 6 is provided on the rotator 30 side, the rotator 30 can be rotated within a predetermined range (for example, up to 45 degrees clockwise when the reference starting position for rotation is 0 degrees) with respect to the device body 10, and the position of the rotator 30 can be easily switched between a position in which the operation member 15 can be operated and a position in which the operation member 15 is guarded. This makes it possible to easily and reliably prevent unintentional changes in settings, and the like due to inadvertent operation of the operation member 15.

In the above embodiment, a timepiece 100 including a rotary device and the rotary device that including a device body 1 that includes an operation member 15 and a rotator 3 that can vary its position by rotation to take a guard position where the operation member 15 can be guarded and a release position where the operation member 15 can be released to be operated are described. Even a timepiece 300 including a variable device and a variable device with a variable member that can take a guard position in which the operation member 15 can be guarded and a release position in which the operation member 15 can be released and made operable have the same effect as this embodiment.

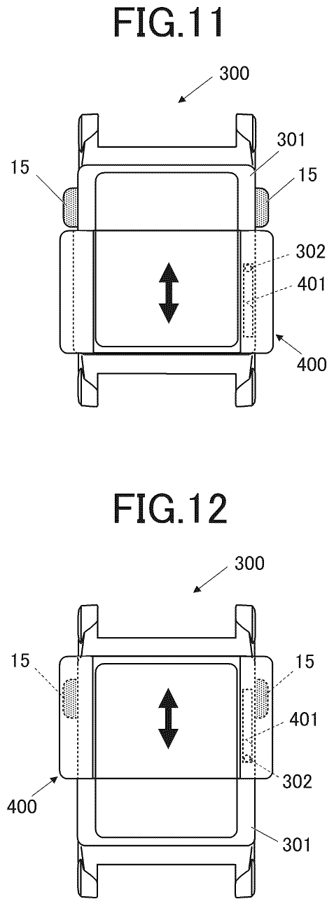

In this case, as shown in FIGS. 11 and 12, the device body (body case 301) is formed in a rectangular shape, for example. For example, the timepiece 300 shown in FIGS. 11 and 12 shows an example in which operation members 15 are provided on both side portions in the upper (12 o'clock) side of the body case 301. The position and number of operation members 15 are not limited to the illustrated examples. For example, operation members may be provided only on either side portion of the body case. The operation member may also be provided on a side portion in the lower side (6 o'clock) or the like of the body case.

The variable member (cover) 400 of the variable device provided to the timepiece 300 is a frame-shaped member provided on the upper surface of the device body (body case 301), as shown in FIGS. 11 and 12, for example. In the illustrated example, the variable member 400 of the variable device is formed long in the horizontal direction (lateral direction in FIGS. 11 and 12) of the device body (body case 301). The variable member 400 moves relative to the device body by sliding in the vertical direction (indicated by the bold arrows in FIGS. 11 and 12) from 12 o'clock to 6 o'clock in the analog timepiece. It is preferable that the variable member 400 is composed of a transparent member at least in the portion overlapping the display section, and the like, so that the surface side of the body case 301 (display section, and the like provided on the surface side) is not hidden even when the variable member 400 moves along the upper surface side of the body case 301. Alternatively, the frame portion in the vertical direction in the illustration may be made as small (thin) as possible so that the portion of the variable member 400 that overlaps the display section, and the like. is reduced as much as possible. In this case, a recess is also provided on either the upper surface side of the device body (body case 301) or the variable member 400, and a restrictor is provided on either the upper surface side of the device body or the variable member 400 at a position corresponding to the recess.

FIGS. 11 and 12 illustrate a case in which the restrictor 302 is provided on the upper surface side of the body case 301 and the recess 401 is provided on the back surface side of the variable member 400. In the illustrated example, the recess 401 is formed long in the horizontal direction, and the restrictor 302 is positioned on the upper surface side of the body case 301, at a position corresponding to the recess 401, such as approximately in the center of the vertical direction. The illustration shows a case in which the restrictor 302 and recess 401 are arranged only on the 3 o'clock side of the timepiece, but the position and number of the restrictor 302 and recess 401 are not limited to the illustration. For example, the restrictor 302 and recess 401 may be provided on the side portion of the 9 o'clock side of the timepiece, or on the 3 o'clock side and the 9 o'clock side, respectively. When the restrictor 302 and recess 401 are placed in symmetrical positions respectively, more stable sliding movement is possible. In either case, the variable member 400 is configured to be movable relative to the device body (body case 301) in the range corresponding to the length of the recess 401.

The direction of slide movement of the variable member is not limited to the vertical direction as shown in FIGS. 11 and 12. For example, when the operation member 15 is provided on either side portion of the 3 o'clock side or the 9 o'clock side of the device body (body case 301), the variable member of the variable device may be formed long (longitudinal direction in FIGS. 11 and 12) in the device body (body case 301) to slide in the horizontal direction from 3 o'clock-9 o'clock side in the analog timepiece to move relative to the device body. In this case, the recess is formed long in the longitudinal direction and the restrictor is positioned on the upper surface side of the body case 301, at a position corresponding to the recess, such as approximately in the center of the left-right direction. In this case, the recess is also provided on either the upper surface side of the device body or the variable member, and the restrictor is provided on either the upper surface side of the device body or the variable member, at a position corresponding to the recess. The variable member is configured to be movable relative to the device body within a range corresponding to the length of the recess.

For example, if a variable device includes a variable member as described above that varies its position by sliding in the vertical or horizontal direction, even when the rectangular body case as shown in FIGS. 11 and 12 is provided, it is possible to easily take the guard position, where the operation member 15 can be guarded, and the release position, where the operation member 15 can be released and made operable, by using the variable member. Therefore, the structure that can easily switch the state of the operation member 15 can be widely applied to devices such as rectangular timepieces, where it is difficult to place a member that rotates and moves, thereby increasing the degree of freedom in the external design of the timepiece and other devices.

The covers, that is, the rotators shown in FIGS. 1 to 10 and the variable members shown in FIGS. 11 and 12, need not all have a size that corresponds to the entire upper surface of the device body. That is, the rotator and the variable member (cover) need only be configured so that they can take a guard position in which the operation member 15 can be guarded and a release position in which the operation member 15 can be released to be operated, by varying its position. For example, a rotator or a variable member (cover) may be a part of the upper surface of the device body that can take a position where the operation member 15 can be guarded and a position where the operation member 15 can be operated. The operation member does not have to be located on the outer circumference side surface of the device body 1. The operation member may be provided on the upper surface of the outer circumference side of the device body 1, as long as the cover can take a guard position where the operation member can be guarded, and a release position where the operation member can be released and operated. The operation member is not limited to buttons, but can also be a display section such as a touch panel.

In this embodiment, the case in which the rotary device and the variable device are applied to a timepiece is shown as an example. However, devices to which the rotary and variable devices are applied are not limited to timepieces.

For example, rotary device and variable device may be pedometers, heart rate monitors, altimeters, barometers, and the like, or so-called smart watches.

Although some embodiments of the invention have been described above, the scope of the invention is not limited to the embodiments described above, but includes the scope of the invention described in the claims and its equivalents.

1. A variable device comprising:
a device body that includes an operation member on an outer circumference side; and
a cover that is provided on one surface side of the device body and movable in a direction substantially parallel to the one surface of the device body to take a guard position in which the operation member is allowed to be guarded and a release position in which the operation member is released and allowed to be operated, wherein
one of the device body or the cover has a recess of a length corresponding to a movable amount of the cover along a movable direction of the cover,
a restrictor placed in the recess is provided on the other of the device body or the cover, and
the cover is movable with respect to the device body only within a range corresponding to the length of the recess.

2. The variable device according to claim 1, wherein
the outer circumference side of the device body is a side portion of the device body, and
one end side in the movable range of the cover is the guard position and the other end side is the release position.

3. The variable device according to claim 1, wherein
the cover is a substantially annular rotator that is provided on an upper surface of the device body so as to be rotatable, and varies a position thereof by rotating around an annular center, and
the recess is of the length corresponding to a rotation amount of the rotator along a rotation direction of the rotator.

4. The variable device according to claim 2, wherein
the cover is a substantially annular rotator that is provided on an upper surface of the device body so as to be rotatable, and varies a position thereof by rotating around an annular center, and
the recess is of the length corresponding to a rotation amount of the rotator along a rotation direction of the rotator.

5. The variable device according to claim 1, wherein
the restrictor protrudes toward a bottom surface of the recess, and is forced in a protruding direction so as to trace the bottom surface of the recess.

6. The variable device according to claim 2, wherein
the restrictor protrudes toward a bottom surface of the recess, and is forced in a protruding direction so as to trace the bottom surface of the recess.

7. The variable device according to claim 1, wherein
both ends of a length direction in the recess are deep in a protruding direction of the restrictor, relative to a center of the length direction.

8. The variable device according to claim 2, wherein
both ends of a length direction in the recess are deep in a protruding direction of the restrictor, relative to a center of the length direction.

9. The variable device according to claim 1, wherein
a bottom surface of the recess includes a sloping surface that slopes toward a central portion of a length direction between one end of the length direction and the central portion of the length direction, and between the other end of the length direction and the central portion of the length direction.

10. The variable device according to claim 2, wherein
a bottom surface of the recess includes a sloping surface that slopes toward a central portion of a length direction between one end of the length direction and the central portion of the length direction, and between the other end of the length direction and the central portion of the length direction.

11. The variable device according to claim 9, wherein
at one end side and the other end side of the cover in the length direction of the recess, a stop surface is formed at a steeper angle than the sloping surface with respect to the bottom surface of the recess.

12. The variable device according to claim 10, wherein
at one end side and the other end side of the cover in the length direction of the recess, a stop surface is formed at a steeper angle than the sloping surface with respect to the bottom surface of the recess.

13. The variable device according to claim 3, wherein
an indicator is provided on a surface of the rotator to indicate that the rotator is in the release position when the rotator varies the position thereof to the release position.

14. The variable device according to claim 4, wherein
an indicator is provided on a surface of the rotator to indicate that the rotator is in the release position when the rotator varies the position thereof to the release position.

15. The variable device according to claim 3, wherein
an indicator that shows a movable range of the rotator is provided on a surface of the rotator.

16. The variable device according to claim 3, wherein
an indicator that shows a position of the operation member is provided on a surface of the rotator.

17. A timepiece comprising the variable device according to claim 1.

18. A rotary device comprising:
a device body that includes an operation member on an outer circumference side; and
a rotator that is provided on one surface side of the device body and rotates around an annular center to take a guard position in which the operation member is allowed to be guarded and a release position in which the operation member is released and allowed to be operated, wherein
one of the device body or the rotator has a recess of a length corresponding to a rotation amount of the rotator along a rotation direction of the rotator,
a restrictor placed in the recess is provided on the other of the device body or the rotator, and
the rotator is rotatable with respect to the device body only within a range corresponding to the length of the recess.

19. A timepiece comprising the rotary device according to claim 18.

20. The timepiece according to claim 19, wherein
the rotator of the rotary device is a variable member,
an indicator is provided on a surface of the rotator, and
when the indicator is at 12 o'clock position, the rotator is in the release position in which the operation member is released.
